(19) United States
(12) Patent Application Publication
(10) Pub. No.: US 2025/0329906 A1
(43) Pub. Date: Oct. 23, 2025

(54) SECONDARY BATTERY AND METHOD FOR MANUFACTURING THE SAME

(71) Applicant: Samsung SDI Co., Ltd., Yongin-si (KR)

(72) Inventor: Ki Youn Jun, Yongin-si (KR)

(73) Assignee: Samsung SDI Co., Ltd., Yongin-si (KR)

(21) Appl. No.: 18/906,795

(22) Filed: Oct. 4, 2024

(30) Foreign Application Priority Data
Apr. 22, 2024 (KR) 10-2024-0053209

(51) Int. Cl. H01M 50/645; B60L 50/64; H01M 50/103; H01M 50/119; H01M 50/15

(52) U.S. Cl. CPC H01M 50/645; H01M 50/103; H01M 50/119; H01M 50/15; B60L 50/64; H01M 2220/20

(57) ABSTRACT

Embodiments relate to a secondary battery, in which a concave area is provided in a case, and a negative pressure is maintained to secure a space, into which an electrolyte is injected, and reduce deformation due to an internal pressure, and which has a buffer structure against the falling, and a method for manufacturing the same. The secondary battery includes an electrode assembly provided with a first electrode plate and a second electrode plate, a case which has an interior space therein and in which the electrode assembly is accommodated, and a cap plate configured to seal an opening of the case. The case has a concave area that is concave toward the interior space of the case in each of two long side surfaces facing each other, and the interior space sealed by the case and the cap plate is in a negative pressure state.

### CROSS-REFERENCE TO RELATED APPLICATIONS

This present application claims priority to and the benefit under 35 U.S.C. § 119(a)-(d) of Korean Patent Application No. 10-2024-0053209, filed on Apr. 22, 2024, in the Korean Intellectual Property Office, the entire disclosure of which is incorporated herein by reference.

### FIELD

Embodiments relate to a secondary battery and a method for manufacturing the same.

### BACKGROUND

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The above information disclosed in this Background section is for enhancement of understanding of the background of the present disclosure, and therefore, it may contain information that does not constitute related (or prior) art.

### SUMMARY

Aspects of some embodiments of the present disclosure provide a secondary battery, in which a concave area is provided in a case, and a negative pressure is maintained to secure a space, into which an electrolyte is injected, and reduce deformation due to the internal pressure, and which has a buffer structure due to falling.

These and other aspects and features of the present disclosure will be described in or will be apparent from the following description of embodiments of the present disclosure.

According to some embodiments, a secondary battery includes: an electrode assembly provided with a first electrode plate and a second electrode plate; a case which has an interior space therein and in which the electrode assembly is accommodated; and a cap plate configured to seal an opening of the case to seal the interior space of the case, wherein the case has concave areas in each of two long side surfaces of the case that face each other, the concave areas being concave toward the interior space of the case, and the inside sealed by the case and the cap plate is in a negative pressure state.

The cap plate may include an electrolyte injection hole passing between top and bottom surfaces of the cap plate, and the electrolyte injection hole may be sealed by a stopper.

Each of the concave areas may be provided at a central portion of a respective one of the two long side surfaces of the case.

In the case, a distance between the two long side surfaces in upper and lower areas of the case may be greater than a distance between the two long side surfaces in the central portion at which the concave area is defined.

In the electrode assembly, each of two long side surfaces of the electrode assembly, which each face respective ones of the two long side surfaces of the case, are concave toward a center of the case.

The case may include: a rectangular bottom surface; the two long side surfaces, the two long side surfaces extending upward from long sides of the rectangular bottom surface; and two short side surfaces extending upward from short sides of the rectangular bottom surface to connect the two long side surfaces to each other.

The case may be provided to be integrated.

The case may be made of a conductive metal.

The secondary battery may further include an electrode terminal passing through the cap plate and electrically connected to the first electrode plate of the electrode assembly inside the case, wherein the cap plate may be electrically connected to the second electrode plate of the electrode assembly.

According to some embodiments, a method for manufacturing a secondary battery includes: accommodating an electrode assembly including a first electrode plate and a second electrode plate into a case and sealing an opening of the case with a cap plate having an electrolyte injection hole; injecting an electrolyte into the case through the electrolyte injection hole; pressing two long side surfaces of the case by a pressing member, the two long side surfaces of the case facing each other; and sealing the electrolyte injection hole in the state in which the two long side surfaces of the case are pressed by the pressing member.

The electrolyte injection hole may be sealed by a stopper such that an interior space within the case may be in a negative pressure state.

The pressing member may press a central portion of each of the two long side surfaces of the case so that each of the two long side surfaces has a concave area that is concave toward the interior space of the case.

The pressing member may press the central portion of each of two long side surfaces of the case so that long side surfaces of the electrode assembly, which each face respective ones of the two long side surfaces of the case, are pressed to be concave toward a center of the case.

In the case, subsequent to the pressing, a distance between the two long side surfaces in upper and lower areas of the case may be greater than a distance between the two long side surfaces in the central portion at which the concave area is defined.

The case may comprise a rectangular bottom surface; the two long side surfaces, the two long side surfaces extending upward from long sides of the rectangular bottom surface; and two short side surfaces extending upward from short sides of the rectangular bottom surface to connect the two long side surfaces to each other.

The case may be provided to be integrated.

The case may be made of a conductive metal.

The secondary battery may further comprise an electrode terminal passing through the cap plate; and the method may further comprise electrically connecting the electrode terminal to the first electrode plate of the electrode assembly inside the case; and electrically connecting the cap plate to the second electrode plate of the electrode assembly.

However, the aspects and features of the present disclosure are not limited to those described above, and other aspects and features not expressly described herein will be clearly understood by a person skilled in the art from the description of example embodiments of the present disclosure described below.

### BRIEF DESCRIPTION OF THE DRAWINGS

The following drawings attached to the present specification illustrate embodiments of the present disclosure, and further describe aspects and features of the present disclosure together with the detailed description of the present disclosure. Thus, the present disclosure should not be construed as being limited to the drawings:

FIG. 1A illustrates a perspective view of a secondary battery, according to some embodiments;

FIG. 1B illustrates an exploded perspective views of a secondary battery, according to some embodiments;

FIG. 2A illustrates a cross-sectional view taken along the line 2a-2b in the secondary battery of FIG. 1A, according to some embodiments;

FIG. 2B illustrates a cross-sectional view taken along the line 2b-2b′ in the secondary battery of FIG. 1A, according to some embodiments;

FIGS. 3A to 3C illustrate transversely cross-sectional views of an electrolyte injection hole in different stages of a method for manufacturing a secondary battery, according to some embodiments;

FIGS. 4A and 4B illustrate perspective views of a battery pack including an exemplary secondary battery, according to some embodiments;

FIG. 5A illustrates a perspective of a vehicle including an exemplary battery pack, according to some embodiments; and

FIG. 5B illustrates a side view of a vehicle including an exemplary battery pack, according to some embodiments.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112 (a) and 35 U.S.C. § 132 (a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

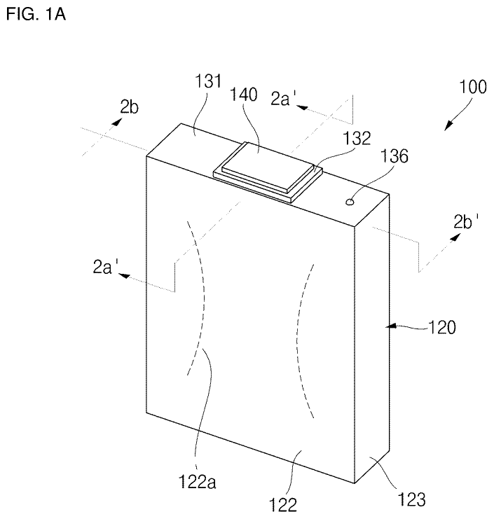

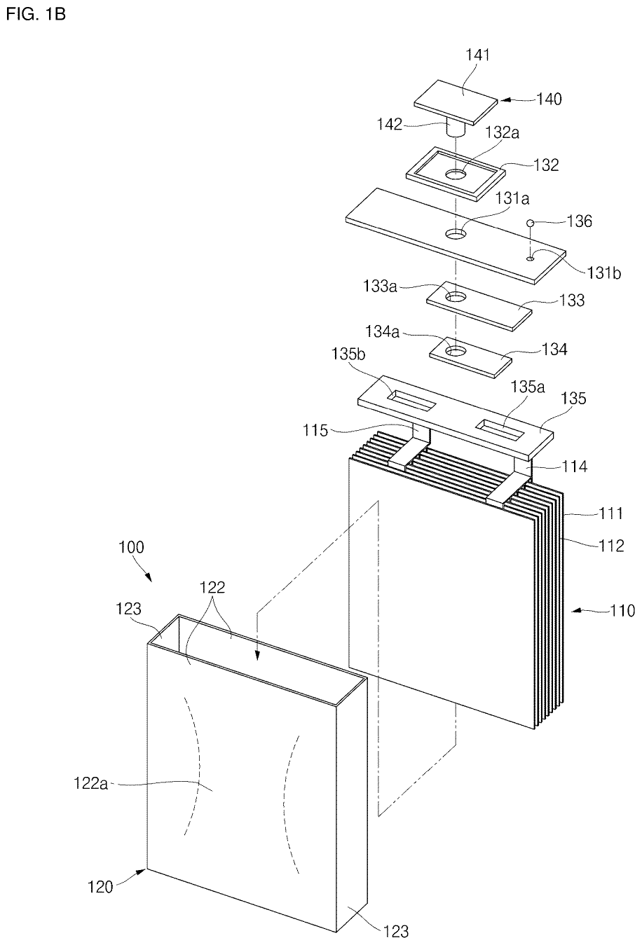

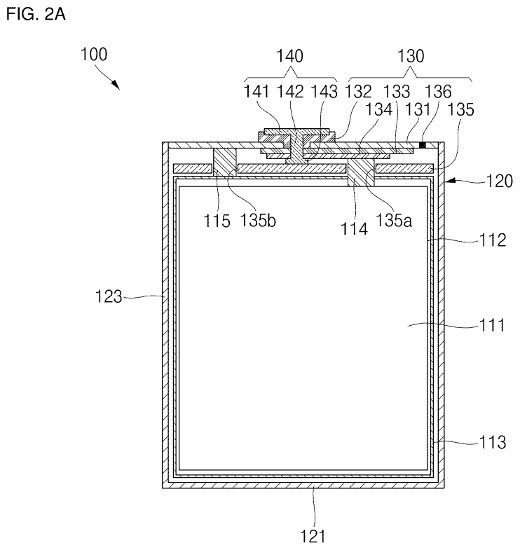

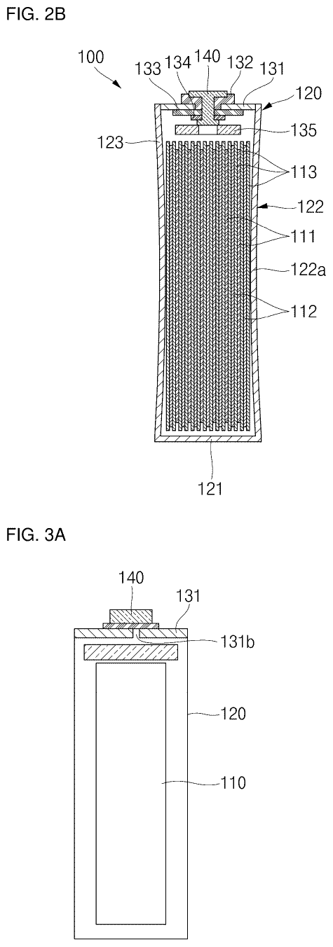

FIGS. 1A and 1B illustrate perspective and exploded perspective views of a secondary battery according to some embodiments. FIGS. 2A and 2B illustrate cross-sectional views taken along lines 2a-2b and 2b-2b′ in the secondary battery of FIG. 1A, respectively.

A secondary battery 100 illustrated in FIGS. 1A, 1B, 2A, and 2B may include an electrode assembly 110, a case 120, a cap assembly 130, and an electrode terminal 140. The secondary battery 100 according to some embodiments may be referred to as a prismatic secondary cell or battery.

The electrode assembly 110 may be provided by stacking or winding a stack of a first electrode plate 111, a separator 113, and a second electrode plate 112, each of which has a thin plate or film shape. Here, the first electrode plate 111 may operate at a first polarity, for example, a positive electrode, and the second electrode plate 112 may operate at a second polarity, for example, a negative electrode. In some embodiments, the electrode assembly 110 may have a jelly roll shape in which the first electrode plate 111, the separator 113, and the second electrode plate 112 are stacked and wound.

The first electrode plate 111 may be formed by applying a first electrode active material such as a transition metal oxide on a first electrode collector formed of metal foil such as aluminum foil, and includes a first electrode non-coating portion on which the first electrode active metal is not applied. The first electrode non-coating portion may provide a passage through which current flows between the first electrode plate 111 and the outside. The first electrode non-coating portion may be provided to protrude toward an upper portion of the electrode assembly 110. In some embodiments, a plurality of first electrode non-coating portions may be welded to each other to provide one first current collection tab 114. The first current collection tab 114 may protrude upward from one side of an upper end of the electrode assembly 110. The first current collection tab 114 may be formed by punching the first electrode non-coating portion of the first electrode plate 111 or formed by coupling a separate tab configuration to the first electrode non-coating portion.

The second electrode plate 112 may be formed by applying a second electrode active material such as graphite or carbon on a second electrode collector formed of metal foil such as nickel or copper foil, and includes a second electrode non-coating portion on which the second electrode active metal is not applied. In some embodiments, the second electrode non-coating portion may be provided to protrude toward an upper portion of the electrode assembly 110.

In some embodiments, a plurality of second electrode non-coating portions may be welded to each other to provide one second current collection tab 115. The second current collection tab 115 may protrude upward from the other side of an upper end so as to be spaced apart from the first current collection tab 114. In some embodiments, the first current collection tab 114 and the second current collection tab 115 may be provided as separate lead tabs rather than the electrode non-coating portions.

The separator 113 may be disposed between the first electrode plate 111 and the second electrode plate 112 to prevent short circuit from occurring and enable movement of lithium ions. The separator 113 may be formed of polyethylene, polypropylene, or combination film of polyethylene and polypropylene. The material of the separator 113 may not be limiting to the scope of the present disclosure.

In some embodiments, the electrode assembly 110 may be accommodated in the case 120 together with the electrolyte. The electrolyte may include an organic solvent such as ethylene carbonate (EC), propylene carbonate (PC), diethyl carbonate (DEC), ethyl methyl carbonate (EMC), or dimethyl carbonate (DMC), and a lithium salt such as LiPF6 or LiBF4. The electrolyte may be liquid, solid, or gel.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiaA1−bXbO2−cDc (0.90≤a≤1.8, 0≤b≤0.5, 0≤c≤0.05); LiaMn2−bXbO4−cDc (0.90≤a≤1.8, 0≤b≤0.5, 0≤c≤0.05); LiaNi1−b−cCobXcO2−αDα (0.90≤a≤1.8, 0≤b≤0.5, 0≤c≤0.5, 0<α<2); LiaNi1−b−cMnbXcO2−αDα (0.90≤a≤1.8, 0≤b≤0.5, 0≤c≤0.5, 0<α<2); LiaNibCocL1dGeO2 (0.90≤a≤1.8, 0≤b≤0.9, 0≤c≤0.5, 0≤d≤0.5, 0≤e≤0.1); LiaNiGbO2 (0.90≤a≤1.8, 0.001≤b≤0.1); LiaCoGbO2 (0.90≤a≤1.8, 0.001≤b≤0.1); LiaMn1−bGbO2 (0.90≤a≤1.8, 0.001≤b≤0.1); LiaMn2GbO4 (0.90≤a≤1.8, 0.001≤b≤0.1); LiaMn1−gGgPO4 (0.90≤a≤1.8, 0≤g≤0.5); Li(3−f)Fe2(PO4)3 (0≤f≤2); and LiaFePO4 (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L1 is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOx (0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al2O3, SiO2, TiO2, SnO2, CeO₂, MgO, NiO, CaO, GaO, ZnO, ZrO₂, Y2O3, SrTiO3, BaTiO3, Mg(OH)2, boehmite, and combinations thereof but is not limited thereto.

The organic material and the inorganic material may be mixed in one coating layer or may be in the form of a coating layer containing an organic material and a coating layer containing an inorganic material that are laminated on each other.

The case 120 may have an approximately hexahedral shape with an opening through which the electrode assembly 110 is inserted and seated. A cap plate 131 may be coupled to the opening of the case 120 to seal the case 120. The case 120 may be made of a conductive metal such as aluminum, an aluminum alloy, nickel-plated steel, or SUS (stainless steel). In some embodiments, an inner surface of the case 120 may be processed to be insulated, thereby preventing the electrical short circuit from occurring inside the case 120.

The case 120 may include a rectangular bottom surface 121 and four side surfaces 122 and 123 extending upward from four edges of the bottom surface 121. In some embodiments, the sides 122 and 123 may include two long side surfaces 122 extending upward from long sides of the bottom surface 121 and two short side surfaces 123 extending upward from short sides of the bottom surface 121 to connect the two long side surfaces 122 to each other. The two long side surfaces 122 may face each other, and the two short side surfaces 123 may also face each other.

In some embodiments, the two long side surfaces 122 and the two short side surfaces 123 may have the same height. In some embodiments, the bottom surface 121, the long side surfaces 122, and the short side surfaces 123 may be integrated with each other. In some embodiments, the bottom surface 121 may have a curved short side, and each of the two short side surfaces 123 may also have a curved surface. In some embodiments, a shape of each of the short side surfaces 123 of the case 120 may be variously changed depending on a shape of the bottom surface 121.

Each of the two long side surfaces 122 of the case 120 may have a concave area 122a of which a center is generally concave toward the inside of the case 120. For example, a distance between the two long side surfaces 122 of the case 120 may be closer to each other at the concave area 122a than in other areas. In some embodiments, the concave area 122a may be an area on which a central area in a longitudinal direction and a central area in a width direction of the long side surface 122 intersect each other. In some embodiments, the long side surface 122 may have the concave area 122a disposed approximately at the center of the long side surface 122 and may include an upper area, a lower area, both areas being with respect to the concave area 122a. In some embodiments, the concave area 122a of the long side surface 122 may be defined to be concave toward the inside of the case 120, and the other area of the long side surface 122 may have a shape that protrudes further outward.

For example, the case 120 may be pressed between the two long side surfaces 122 by a pressing member to define the concave area 122a. Here, the concave area 122a may be recessed in various forms, such as in a straight line or in a gently parabolic shape toward the electrode assembly 110 and may be recessed in an arc shape to uniformly support external forces. In some embodiments, an internal pressure of the case 120 may have a negative pressure less than an external pressure.

The case 120 may have a larger width in the upper and lower areas compared to the central portion, at which the concave area 122a is defined, to secure a space, into which the electrolyte is injected, and provide a buffer structure against falling. In some embodiments, the width may be a distance between the two long side surfaces 122. In some embodiments, a space and an internal pressure, at which an expansion of a volume of the negative electrode is offset, may be secured in advance.

The cap assembly 130 may include a cap plate 131, a gasket 132, an insulating plate 133, a terminal plate 134, and an insulating case 135.

The cap plate 131 may be coupled to the top opening of the case 120 to seal the case 120. The cap plate 131 may have a substantially flat plate shape and may be a metal plate having a size and shape corresponding to those of the upper opening of the case 120. A second current collection tab 115 of the electrode assembly 110 passing through the insulating case 135 may be welded to a bottom surface of the cap plate 131. In some embodiments, the cap plate 131 may have the same polarity as the second electrode plate 112 of the electrode assembly 110.

A terminal hole 131a passing between top and bottom surfaces of the cap plate 131 may be defined in a center of the cap plate 131, and a pillar part 142 of the electrode terminal 140 may be inserted into and coupled to the terminal hole 131a. An electrolyte injection hole through which the electrolyte is injected into the internal space of the case 120 may be further defined at one side of the cap plate 131. In some embodiments, the electrolyte injection hole 131b may be a hole passing between the top and bottom surfaces of the cap plate 131 and may be sealed by a stopper 136 after the electrolyte is injected into the case 120.

The gasket 132 may be disposed between the terminal hole 131a of the cap plate 131 and the electrode terminal 140. The gasket 132 may also be disposed between a head part 141 of the electrode terminal 140 and the cap plate 131. The gasket 132 may be made of an insulating material. The gasket 132 may seal a space between the cap plate 131 and the electrode terminal 140. The gasket 132 may prevent moisture from being permeated into the secondary battery 100 or prevent the electrolyte inside the secondary battery 100 from leaking to the outside.

The insulating plate 133 may be disposed between the cap plate 131 and the terminal plate 134 to electrically separate the cap plate 131 and the terminal plate 134 from each other. The insulating plate 133 may be made of an insulating material and may have a substantially flat plate shape. The insulating plate 133 may have a terminal hole 133a passing between top and bottom surfaces thereof at one side. The pillar part 142 of the electrode terminal 140 may pass through the terminal hole 131a of the cap plate 131 and the terminal hole 133a of the insulating plate 133 and be coupled to the terminal plate 134. An upper side of the insulating plate 133 may be in contact with a lower side of the gasket 132.

The terminal plate 134 may be disposed below the insulating plate 133. The terminal plate 134 may have a flat plate shape. The terminal plate 134 may be in contact with and coupled to the lower side of the pillar part 142 of the electrode terminal 140. The terminal plate 134 may be coupled to the lower side of the pillar part 142 of the electrode terminal 140 by welding. In some embodiments, the pillar part 142 of the electrode terminal 140 may be coupled to the terminal hole 134a provided in the terminal plate 134 and then be coupled by a rivet. In the present disclosure, the coupling relationship between the electrode terminal 140 and the terminal plate 134 may not be limited.

The terminal plate 134 may be in contact with and coupled to the first current collection tab 114 of the first electrode plate 111 of the electrode assembly 110. The terminal plate 134 may be electrically connected to the first current collection tab 114 by welding. In some embodiments, the terminal plate 134 may electrically connect the first electrode plate 111 of the electrode assembly 110 to the electrode terminal 140.

The insulating case 135 may be disposed between the cap plate 131 and the electrode assembly 110 and between the terminal plate 134 and the electrode assembly 110. The insulating case 135 may be made of an insulating material and may electrically insulate the electrode assembly 110 from the cap plate 131 or the terminal plate 134. The insulating case 135 may be provided with tab holes 135a and 135b through which the first and second current collection tabs 114 and 115 of the electrode assembly 110 protrude upward. That is, the insulating case 135 may electrically separate the upper part of the electrode assembly 110, from which the first and second current collection tabs 114 and 115 of the electrode assembly 110 are withdrawn, and the cap assembly 130 from each other.

The electrode terminal 140 may include the pillar part 141 and the head part 142. The pillar part 141 may be inserted to pass through the terminal holes 131a, 132a, 133a, and 134a of the cap plate 131, the gasket 132, the insulating plate 133, and the terminal plate 134 so as to be coupled to and electrically connected to the terminal plate 134. In some embodiments, the head part 142 may be disposed above the gasket 150. The electrode terminal 140 may be electrically connected to the first current collection tab 114 of the electrode assembly 110 through the terminal plate 134. In some embodiments, the electrode terminal 140 may be electrically separated from the electrode assembly 110 and the cap plate 131 through the gasket 132, the insulating plate 133, and the insulating case 135, which are insulating members.

In the present disclosure, the secondary battery 100 may be illustrated so that the electrode terminal 140 is provided with one terminal 140, and the one terminal is replaced by the cap plate 131, but in some embodiments, the positive and negative electrode terminals may be provided separately. The structure of the secondary battery 100 may be changed in various manners while, in each embodiment, the electrode assembly 110 is accommodated in the case 120 and has the electrolyte injection hole.

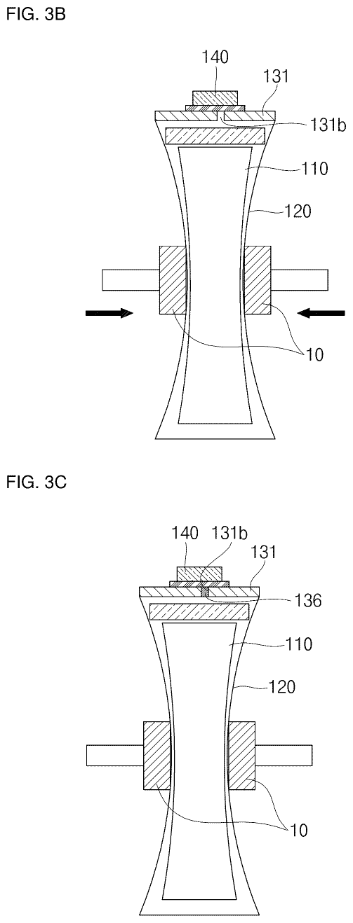

FIGS. 3A to 3C illustrate transversely cross-sectional views of an electrolyte injection hole in respective stages of a method for manufacturing a secondary battery according to some embodiments.

First, in a secondary battery 100 illustrated in FIG. 3A, after an electrode assembly is accommodated in an internal accommodation space of the case 120, a cap assembly 130 may seal an upper opening of the case 120. In some embodiments, an electrode terminal 140 may pass through a cap plate 131 and be electrically connected to a first electrode plate 111 of an electrode assembly 110, and the cap plate 131 may be electrically connected to a second electrode plate 112 of the electrode assembly 110. In some embodiments, the case 120 may have a rectangular parallelepiped shape with one surface opened. In some embodiments, two long side surfaces 122 of the case 120 may be flat surfaces. Both the long side surfaces 122 of the case 120 may be spaced apart from the electrode assembly 110. In some embodiments, a size of the case 120 may be designed to be large so as to have more space compared to the size of the electrode assembly 110. For example, a width of each of both short side surfaces 123 of the case 120 may range from about 130% to about 150% of a width of each of the short side surfaces of the electrode assembly 110. In some embodiments, if the width of the short side 123 of the case 120 is less than about 130% of the width of the short side of the electrode assembly 110, there may be an insufficient space for the electrolyte to be injected inside the case 120. In some embodiments, when the width of the short side 123 of the case 120 exceeds about 150%, a capacity of the secondary battery 100 compared to the size may decrease due to an unnecessary increase in size of the case 120.

In some embodiments, after the case 120 and the cap assembly 130 of the secondary battery 100 are coupled to each other, an electrolyte may be injected into the case 120 through an electrolyte injection hole 131b of the cap plate 131. In some embodiments, an internal space of the case 120 of the secondary battery 100 may include a volume of the electrode assembly 110 which determines capacity of the battery, a space for the electrolyte injection, and a clearance.

Thereafter, in the secondary battery 100 illustrated in FIG. 3B, an approximately central portion of each of both long side surfaces 122 of the case 120 may be pressed toward the inside of the case 120 by a pressing member 10. For example, the pressing member 10 may be in contact with both the long side surfaces 122 of the case 120 to press both the long side surfaces 122 toward the electrode assembly 110. In some embodiments, the pressing member 10 may press the central portion of each of the long side surfaces 122, which are easily deformed compared to the pressure applied by the case 120. In some embodiments, an area pressed by the pressing member 10 may be about 30% to about 70% of the total area of the long side surface 122 of the case 120. The pressing members 10 at both the sides, which press both the long side surfaces 122, may have similar sizes and may press the same central area on both the long side surfaces 122.

In some embodiments, even if the internal space of the case 120 is reduced by pressing both the long side surfaces 122 of the case 120, the size of the case 120 may be initially set to be larger than that of the electrode assembly to secure a clearance into which the electrolyte is injected.

In some embodiments, if the long side surfaces 122 of the case 120 are pressed by the pressing member 10, the long side surfaces of the electrode assembly 110 may also be pressed. In some embodiments, the long side surfaces of the electrode assembly 110 may be surfaces that face the long side surfaces 122 of the case 120. In some embodiments, a central area of each of the long side surfaces of the electrode assembly 110 may be concave to correspond to each of the long side surfaces 122 of the case 120. In some embodiments, the long side surfaces of the electrode assembly 110 may also be pressed by the pressing of the pressing member 10, and thus, a gas and air remaining inside the electrode assembly 110 may also be removed.

A magnitude of the pressure of the pressing member 10 may be a pressure at which a concave area 122a is defined in the case 120, and also, at which the long side surfaces of the electrode assembly 110 are pressed. The magnitude of the pressure applied by the pressing member 10 to the case 120 may vary depending on a thickness and size of the case 120.

Thereafter, in the secondary battery 100 illustrated in FIG. 3C, the electrolyte injection hole 131b may be sealed by a stopper 136 in the state in which both the long side surfaces 122 of the case 120 are pressed by the pressing member 10. As a result, the internal pressure of the case 120 may have a negative pressure less than an external pressure. In some embodiments, after the electrolyte injection hole 131b of the secondary battery 100 is sealed by the stopper 136, the pressure of the pressing member 10 may be released.

The secondary battery 100 may be provided with a concave area 122a in which a central portion of each of the long side surfaces 122 is pressed by the pressing member 10 so as to be concave. The secondary battery 100 may have a larger width in upper and lower areas compared to the central portion, at which the concave area 122a is defined, to secure a space, into which the electrolyte is injected, and provide a buffer structure against falling. In some embodiments, the width may be a distance between the two long side surfaces 122.

In some embodiments, a space and an internal pressure, at which an expansion of a volume of the negative electrode is offset, may be secured in advance. In some embodiments, while the long side surfaces 122 on both sides of the secondary battery 100 are pressurized, the electrolyte injection port 131b is sealed by the stopper 136, thereby minimizing the tolerance inside the case 120.

In the case, subsequent to the pressing, a distance between the two long side surfaces in upper and lower areas of the case may be greater than a distance between the two long side surfaces in the central portion at which the concave area is defined.

The case may comprise a rectangular bottom surface; the two long side surfaces, the two long side surfaces extending upward from long sides of the rectangular bottom surface; and two short side surfaces extending upward from short sides of the rectangular bottom surface to connect the two long side surfaces to each other.

The case may be provided to be integrated.

The case may be made of a conductive metal.

The secondary battery may further comprise an electrode terminal passing through the cap plate; and the method may further comprise electrically connecting the electrode terminal to the first electrode plate of the electrode assembly inside the case; and electrically connecting the cap plate to the second electrode plate of the electrode assembly.

According to another aspect of the present invention, a battery pack manufactured using a battery with an improved structure and a vehicle including the same can be provided.

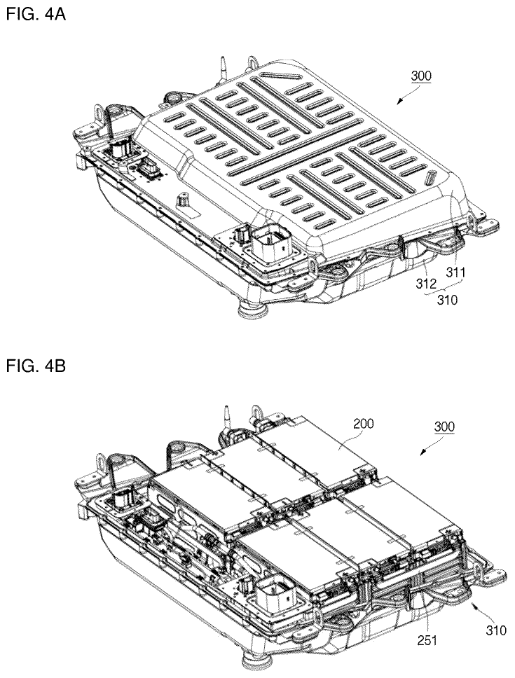

FIGS. 4A and 4B are perspective views showing an exemplary battery pack 300. The battery pack 300 may include a plurality of battery modules 200 and a housing 310 configured to accommodate the plurality of battery modules 200. For example, the housing 310 may include a first housing 311 and a second housing 312, which are coupled to each other in directions facing each other with the plurality of battery modules 200 interposed therebetween. The plurality of battery modules 200 may be electrically connected to each other using bus bars 251. The plurality of battery modules 200 may be electrically connected to each other in series, in parallel, or in a combination thereof, so that desired electrical output may be obtained.

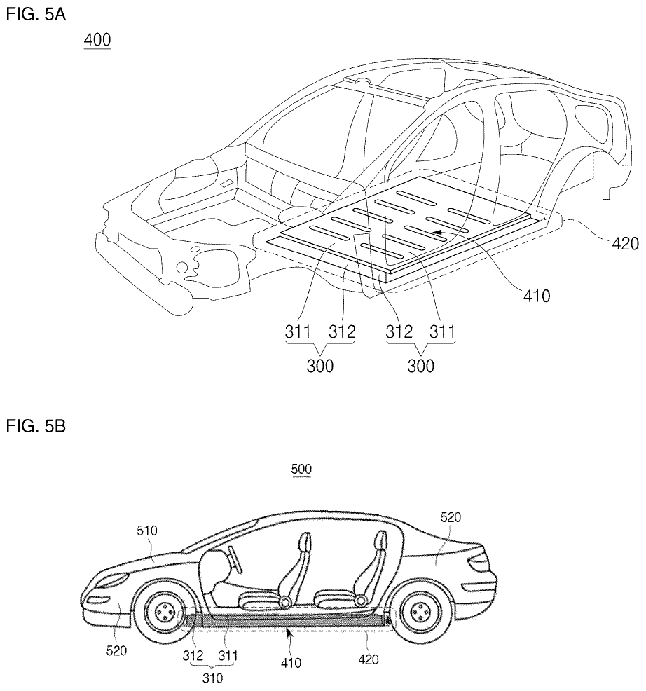

FIGS. 5A and 5B are, respectively, a perspective view showing an exemplary vehicle body 400 and a side view showing an exemplary vehicle 500. As shown in FIG. 5A, the battery pack 300 may include a battery pack cover 311 (which may correspond to the first housing), which is a portion of a vehicle underbody 410, and a pack frame 312 (which may correspond to the second housing), which is disposed beneath the vehicle underbody 410. The battery pack cover 311 and the pack frame 312 may be integrally formed with a vehicle bottom portion 420. The vehicle underbody 410 may separate the interior and the exterior of the vehicle from each other, and the pack frame 312 may be disposed outside the vehicle.

As shown in FIG. 5B, the vehicle 500 may include a vehicle body 400 and various parts coupled to the vehicle body 400, such as a hood 510 located at the front portion of the vehicle and fenders 520 located at the front and rear portions of the vehicle. The vehicle 500 may include the battery pack 300 including the battery pack cover 311 and the pack frame 312, and the battery pack 300 may be coupled to the vehicle body 400.

According to some embodiments, the secondary battery in which the concave area may be provided in the case, and the negative pressure may be maintained to secure the space, into which the electrolyte is injected, and reduce the deformation due to the internal pressure, and which has the buffer structure against the falling may be provided.

According to another aspect of the present disclosure, the battery pack manufactured using the battery having the improved structure and the vehicle including the same may be provided.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure and the claims and their equivalents, below.

What is claimed is:

1. A secondary battery comprising:
an electrode assembly provided with a first electrode plate and a second electrode plate;
a case which has an interior space therein and in which the electrode assembly is accommodated; and
a cap plate configured to seal an opening of the case to seal the interior space of the case,
wherein the case has concave areas in each of two long side surfaces of the case that face each other, the concave areas being concave toward the interior space of the case, and
the interior space of the case sealed by the case and the cap plate is in a negative pressure state.

2. The secondary battery as claimed in claim 1, wherein:
the cap plate comprises an electrolyte injection hole passing between top and bottom surfaces of the cap plate, and
the electrolyte injection hole is sealed by a stopper.

3. The secondary battery as claimed in claim 1, wherein each of the concave areas are provided at a central portion of a respective one of the two long side surfaces of the case.

4. The secondary battery as claimed in claim 3, wherein, in the case, a distance between the two long side surfaces in upper and lower areas of the case is greater than a distance between the two long side surfaces in the central portion at which the concave area is defined.

5. The secondary battery as claimed in claim 1, wherein, in the electrode assembly, each of two long side surfaces of the electrode assembly, which each face respective ones of the two long side surfaces of the case, are concave toward a center of the case.

6. The secondary battery as claimed in claim 1, wherein the case comprises:
a rectangular bottom surface;
the two long side surfaces extending upward from long sides of the rectangular bottom surface; and
two short side surfaces extending upward from short sides of the rectangular bottom surface to connect the two long side surfaces to each other.

7. The secondary battery as claimed in claim 6, wherein the case is provided to be integrated.

8. The secondary battery as claimed in claim 1, wherein the case is made of a conductive metal.

9. The secondary battery as claimed in claim 1, further comprising an electrode terminal passing through the cap plate and electrically connected to the first electrode plate of the electrode assembly inside the case,
wherein the cap plate is electrically connected to the second electrode plate of the electrode assembly.

10. A method for manufacturing a secondary battery, the method comprising:
accommodating an electrode assembly comprising a first electrode plate and a second electrode plate into a case and sealing an opening of the case with a cap plate having an electrolyte injection hole;
injecting an electrolyte into the case through the electrolyte injection hole;
pressing two long side surfaces of the case by a pressing member, the two long side surfaces of the case facing each other; and
sealing the electrolyte injection hole in the state in which the two long side surfaces of the case are pressed by the pressing member.

11. The method as claimed in claim 10, wherein the electrolyte injection hole is sealed by a stopper such that an interior space within the case is in a negative pressure state.

12. The method as claimed in claim 10, wherein the pressing member presses a central portion of each of the two long side surfaces of the case so that each of the two long side surfaces has a concave area that is concave toward the interior space of the case.

13. The method as claimed in claim 12, wherein the pressing member presses the central portion of each of two long side surfaces of the case so that long side surfaces of the electrode assembly, which each face respective ones of the two long side surfaces of the case, are pressed to be concave toward a center of the case.

14. The method as claimed in claim 12, wherein, in the case, subsequent to the pressing, a distance between the two long side surfaces in upper and lower areas of the case is greater than a distance between the two long side surfaces in the central portion at which the concave area is defined.

15. The method as claimed in claim 10, wherein the case comprises:
a rectangular bottom surface;
the two long side surfaces extending upward from long sides of the rectangular bottom surface; and
two short side surfaces extending upward from short sides of the rectangular bottom surface to connect the two long side surfaces to each other.

16. The method as claimed in claim 15, wherein the case is provided to be integrated.

17. The method as claimed in claim 10, wherein the case is made of a conductive metal.

18. The method as claimed in claim 10, wherein:
the secondary battery further comprises an electrode terminal passing through the cap plate; and
the method further comprises:
electrically connecting the electrode terminal to the first electrode plate of the electrode assembly inside the case; and
electrically connecting the cap plate to the second electrode plate of the electrode assembly.
